(19) United States
(12) Patent Application Publication
(10) Pub. No.: US 2010/0083194 A1
(43) Pub. Date: Apr. 1, 2010

(54) SYSTEM AND METHOD FOR FINDING CONNECTED COMPONENTS IN A LARGE-SCALE GRAPH

(75) Inventors: Abraham Bagherjeiran, Sunnyvale, CA (US); Jignesh Parmar, Santa Clara, CA (US)

Correspondence Address: Law Office of Robert Bolan, P.O. Box 36, Bellevue, WA, 98009, US

(73) Assignee: YAHOO! INC., Sunnyvale, CA (US)

(21) Appl. No.: 12/239,770

(22) Filed: Sep. 27, 2008

(51) Int. Cl. G06F 17/50

(52) U.S. Cl. 716/2; 716/13

(57) ABSTRACT

An improved system and method for finding connected components in a large-scale graph is provided. In a map-reduce framework, subsets of a collection of edges for unique vertices may be distributed to several mappers. Connected components of subgraphs represented by each subset of edges may be computed by each mapper. Then the sets of edges for connected components of subgraphs may be sorted by vertex. The sets of edges representing connected components of subgraphs may be distributed to one or more reducers to find maximal sets of weakly connected components of the large-scale graph. The sorted sets of edges for each vertex representing the maximal sets of connected components for subgraphs may be merged by a reducer to identify maximal sets of connected components of a graph, and the maximal sets of connected components of a graph may be output.

### FIELD OF THE INVENTION

The invention relates generally to computer systems, and more particularly to an improved system and method for finding connected components in a large-scale graph.

### BACKGROUND OF THE INVENTION

Many models have been proposed to explain the structure and dynamics of social networks. However most of these models are based on simulated graphs or on relatively small graphs compared to real-world graphs of significant size. Furthermore, analysis of the interaction between users in many online applications may be modeled by a large-scale graph in order to determine a social network of online users for instance. Such a graph may model on the order of a billion interactions between hundreds of thousands of users. Large graphs such as the web graph may be described as scale-free in which the degree of nodes is independent of the size of the graph. See for example Albert-Laszlo Barabasi and Reka Albert, Emergence of Scaling in Random Networks, Science, 286:509, 1999.

Computing the connected components in such a large graph is a nontrivial task. In an undirected graph, the set of connected components is the set of maximally connected subgraphs of a graph. Each vertex in the component is connected via a path of edges to all other vertices in the component. In the case of undirected graphs, polynomial time algorithms exist. However, methods such as depth first search or finding eigenvectors cannot be computed easily when the graph is too large for the set of vertices and edges to fit into memory on a single machine. Furthermore, these algorithms are impractical for large graphs where the set of vertices and edges do not fit into memory.

What is needed is a way to efficiently find the connected components of a graph that is too large to fit the set of vertices and edges into memory on a single machine. Such a system and method should be capable of finding the connected components without traversing the edges in the graph and should be capable of finding the connected components in a constant number of passes over the data.

### SUMMARY OF THE INVENTION

The present invention provides a system and method for finding connected components in a large-scale graph. In a map-reduce framework for computing weakly connected components of a large-scale graph, one or more mappers may be operably coupled to one or more reducers. A mapper may receive a collection of edges for unique vertices, find connected components for subgraphs represented by the collection of edges, and output sets of edges for each vertex representing connected components of subgraphs. A mapper may include a subgraph union-find component that finds a maximal set of connected components for subgraphs by executing a union-find algorithm for a collection of edges. A reducer may receive sets of edges for vertices output by the mapper that represent connected components of subgraphs, find connected components for the graph by merging subgraphs of connected components, and outputs sets of edges for vertices representing connected components of the large-scale graph. The reducer may include a graph union-find component that finds a maximal set of connected components for a graph by executing a union-find algorithm for a collection of edges for vertices of subgraphs.

In an embodiment to compute weakly connected components of a large-scale graph, subsets of a collection of edges for unique vertices may be distributed to several mappers. Connected components of subgraphs represented by each subset of edges may be computed. Then the sets of edges for connected components of subgraphs may be sorted by vertex. In an embodiment, the sets of edges representing connected components of subgraphs may be distributed to one or more reducers to find maximal sets of weakly connected components of the large-scale graph. The sorted sets of edges for each vertex representing the maximal sets of connected components for subgraphs may be merged by a reducer to identify maximal sets of connected components of a graph, and the maximal sets of connected components of a graph may be output.

The present invention may be used by many applications for finding connected components in a large-scale graph. In applications such as social network analysis, computing the set of connected components identifies which users are reachable within the social network from a given user. By providing a map-reduce framework for computing weakly connected components of a large-scale graph, the present invention may be scalable for social network applications involving billions of users with hundreds of thousands of communications. Connected components may be computed in parallel across multiple machines on extremely large graphs.

Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for finding connected components in a large-scale graph, in accordance with an aspect of the present invention;

FIG. 3 is a flowchart generally representing the steps undertaken in one embodiment for computing connected components of a large-scale graph in a map-reduce framework, in accordance with an aspect of the present invention;

FIG. 4 is a flowchart generally representing the steps undertaken in one embodiment for computing subgraphs of connected components of a large-scale graph in a map-reduce framework, in accordance with an aspect of the present invention; and

FIG. 5 is a flowchart generally representing the steps undertaken in one embodiment for computing the connected components of a large-scale graph from the connected components of subgraphs in a map-reduce framework, in accordance with an aspect of the present invention.

### DETAILED DESCRIPTION

### Exemplary Operating Environment

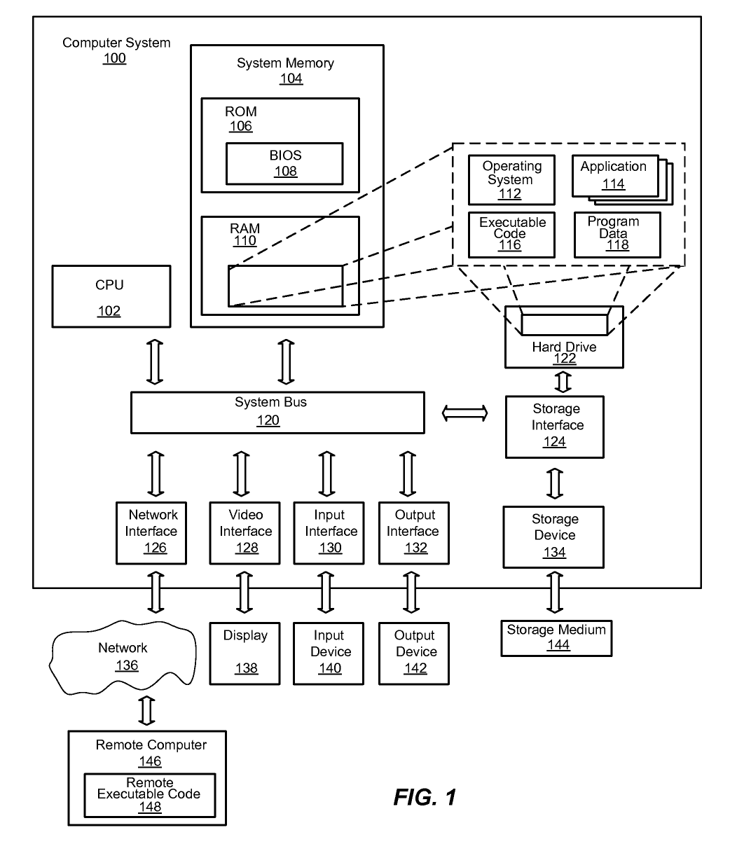

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used. Those skilled in the art will also appreciate that many of the components of the computer system 100 may be implemented within a system-on-a-chip architecture including memory, external interfaces and operating system. System-on-a-chip implementations are common for special purpose hand-held devices, such as mobile phones, digital music players, personal digital assistants and the like.

### Finding Connected Components in a Large-Scale Graph

The present invention is generally directed towards a system and method for finding connected components in a large-scale graph. A map-reduce framework may be provided for computing weakly connected components of a large-scale graph using mappers and reducers. A mapper may receive a collection of edges for unique vertices, find connected components for subgraphs represented by the collection of edges, and outputs sets of edges for each vertex representing connected components of subgraphs. A reducer may receive sets of edges for vertices output by the mapper that represent connected components of subgraphs, find connected components for the graph by merging subgraphs of connected components, and outputs sets of edges for vertices representing connected components of the large-scale graph. Connected components within a set of edges may be computed by executing a union-find algorithm over every edge to partition the set of vertices into disjoint subsets of connected components.

As will be seen, by providing a map-reduce framework for computing weakly connected components of a large-scale graph, the present invention may be scalable for social network applications involving billions of users with hundreds of thousands of communications. Connected components may be computed in parallel across multiple machines on extremely large graphs. As will be understood, the various block diagrams, flow charts and scenarios described herein are only examples, and there are many other scenarios to which the present invention will apply.

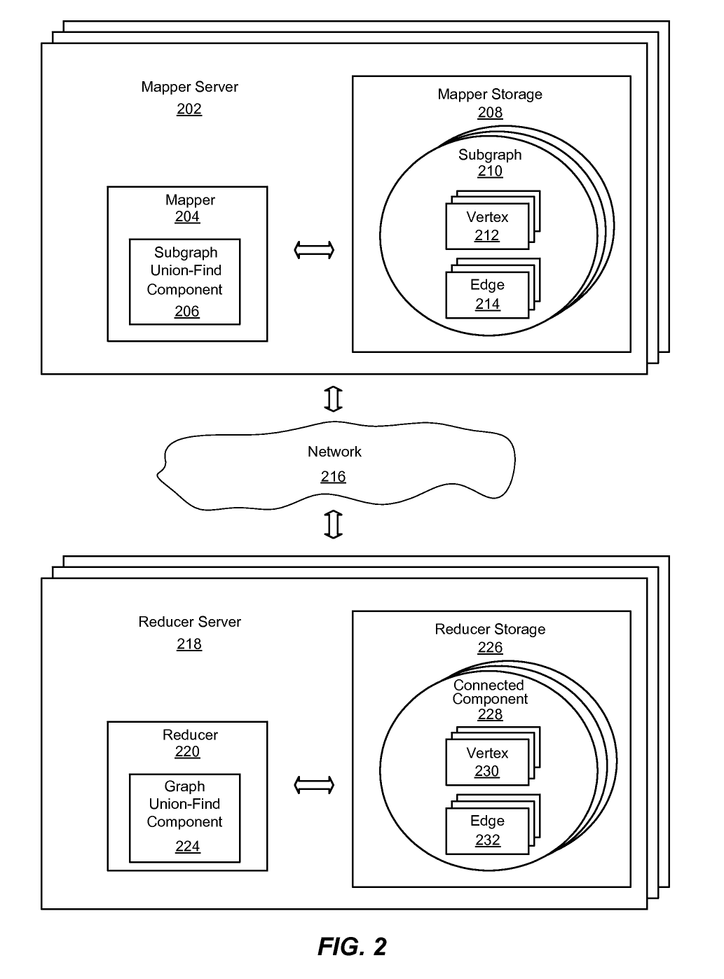

Turning to FIG. 2 of the drawings, there is shown a block diagram generally representing an exemplary architecture of system components for finding connected components in a large-scale graph. Those skilled in the art will appreciate that the functionality implemented within the blocks illustrated in the diagram may be implemented as separate components or the functionality of several or all of the blocks may be implemented within a single component. For example, the functionality for the subgraph union-find component 206 may be included in the same component as the mapper 204, or the functionality of the subgraph union-find component 206 may be implemented as a separate component from the mapper 204. Moreover, those skilled in the art will appreciate that the functionality implemented within the blocks illustrated in the diagram may be executed on a single computer or distributed across a plurality of computers for execution.

In various embodiments, one or more mapper servers 202 may be operably coupled to one or more reducer servers 218 by a network 216. The mapper server 202 and the reducer server 218 may each be a computer such as computer system 100 of FIG. 1. The network 216 may be any type of network such as a local area network (LAN), a wide area network (WAN), or other type of network. The mapper server 202 may include functionality for receiving edges of unique vertices, finding subgraphs of connected components for the edges, and sending a representation of the subgraphs of connected components to a reducer server 218 for finding the connected components of the graph. The mapper server 202 may be operably coupled to a computer storage medium such as mapper storage 208 that may store one or more subgraphs of connected components that include vertices 212 connected by edges 214.

The mapper server 202 may include a mapper 204 that receives a collection of edges for unique vertices, finds connected components for subgraphs represented by the collection of edges, and outputs sets of edges for each vertex representing connected components of subgraphs. The mapper 204 may include a subgraph union-find component 206 that finds a maximal set of connected components for subgraphs by executing a union-find algorithm for a collection of edges. Each of these components may be any type of executable software code that may execute on a computer such as computer system 100 of FIG. 1, including a kernel component, an application program, a linked library, an object with methods, or other type of executable software code. Each of these components may alternatively be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system.

The reducer server 218 may include functionality for receiving sets of edges for vertices that represent connected components of subgraphs, finding the connected components of a graph, and outputting the graph of connected components. The reducer server 218 may be operably coupled to a computer storage medium such as reducer storage 226 that may store a graph of one or more connected components 228 that include vertices 230 connected by edges 232. The reducer server 218 may include a reducer 220 that receives sets of edges for vertices that represent connected components of subgraphs, finds connected components for the graph by merging subgraphs of connected components, and outputs sets of edges for vertices representing connected components of a graph. The reducer 220 may include a graph union-find component 224 that finds a maximal set of connected components for a graph by executing a union-find algorithm for a collection of edges for vertices of subgraphs. The reducer 220 and graph union-find component 224 may be any type of executable software code that may execute on a computer such as computer system 100 of FIG. 1, including a kernel component, an application program, a linked library, an object with methods, or other type of executable software code. Each of these components may alternatively be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system.

There are many applications that may use the present invention to find connected components in a large-scale graph. For instance, the present invention may be used to determine a social network of online users. Consider for example an instant messaging application that allows users to exchange text, voice, and data between peers. Each message may translates to an HTTP request, similar to accessing a web page. Assuming that there is an exchange of messages between two users, a social network of instant messaging users may be represented by an undirected graph of connected components. Such a graph may model on the order of a billion communications between hundreds of thousands of users.

In particular, such a social network may be represented by a graph, G=(V,E), of weakly connected components. A weakly connected component (WCC) is a maximal subgraph of a directed graph such that for every pair of vertices (v,v′) in the subgraph, there is an undirected path from v to v′. From a perspective of sets, the set of WCCs partition the set of vertices into disjoint subsets.

A map-reduce framework may be implemented for finding weakly connected components. In an implementation of a single map-reduce task, there may be a map phase and a reduce phase. In general, the map phase may receives an edge set denoted by (v,v′) in an unspecified order and may find the connected components within the edge set. The map phase may output the resulting connected components to the reducer phase. The reducer phase may receive the connected components grouped by vertex so that the connected components that include the same vertex are presented contiguously to a single reducer for finding the maximal set of weakly connected components of the graph.

In particular, an implementation may distribute the edge set (v,v′)ε E to m mappers, where each mapper mᵢ operates on some subset Eᵢ⊂E such that ∪ᵢEᵢ=E. Each mapper may find the connected components within the set of edges given to it by executing a union-find algorithm over every edge in the subset. For more details about the union-find algorithm, see for example H. Kaplan, N. Shafrir, and R. Tarjan, Union-Find with Deletions, In Proceedings 13th Symposium on Discrete Algorithms (SODA), pages 19-28, 2002. The resulting WCCs on each mapper may be defined by child-parent pairs of vertices, {(vₓ,pₓ)|x ε vᵢ}, such that all child vertices, vₓ, with the same parent vertex, pₓ, belong in the same WCC. A single reducer may execute on the child-parent pairs of vertices, (vₓ,pₓ), that sorts the pairs by child vertex value, and resolves any conflicts if a child vertex belongs to multiple parent vertices. Such a conflict can occur if one mapper assigns a child vertex v to a parent p and another mapper assigns the same child vertex to a different parent p′≠p. The conflicting parent vertices are resolved by running a union-find algorithm over the set of conflicting parent and child vertices. The parents of the parent vertices (grandparents) resulting from execution of the union-find algorithm denote the merged WCCs which may be output as grandparent-parent-child triples (p′,p,v) of vertices. Thus, two vertices v and v′ belong to the same WCC denoted by p′ if there exists triples (p′,·,v) and (p′,·,v′).

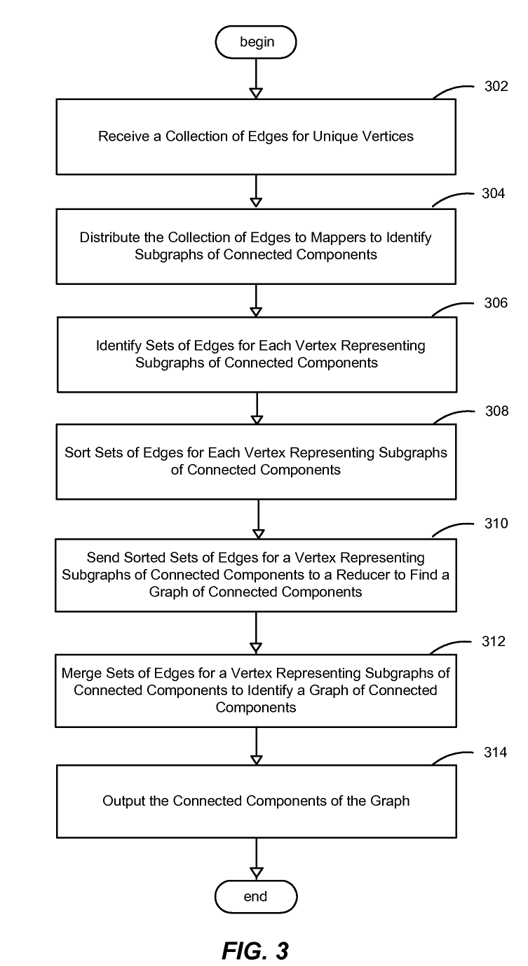

The overall process of finding connected components in a large-scale graph may be represented by FIG. 3 which presents a flowchart for generally representing the steps undertaken in one embodiment for computing connected components of a large-scale graph in a map-reduce framework. At step 302, a collection of edges may be received for unique vertices. For example, each edge in a collection of edges may represent a communication between two users. At step 304, the collection of edges may be distributed to mappers that identify sets of edges for each vertex representing subgraphs of connected components. For the graph G=(V,E) where G={g₁,g₂, . . . ,gₘ}, subsets of edges denoted by gᵢ=(vᵢ,eᵢ) may be distributed to m mappers. In an embodiment, a mapper executing on a mapper server may distribute subsets of the collection of edges to one or more mappers executing on other mapper servers. At step 306, sets of edges may be identified for each vertex that may represent subgraphs of connected components. In an embodiment, a subgraph union-find component may execute a union-find algorithm for each edge (v,v′)ε gᵢ in the sets of edges to find the maximal sets of connected components for subgraphs represented by child-parent pairs of vertices, (vₓ,pₓ).

At step 308, the sets of edges for each vertex representing the maximal sets of connected components for subgraphs may be sorted by child vertex value. The sorted sets of edges for each vertex may then be sent at step 310 to one or more reducers to find a graph of maximal sets of connected components. In an embodiment, a reducer may execute on the same computer as one or more mappers. In various embodiments, a reducer may execute on one or more reducer servers. At step 312, sorted sets of edges for each vertex representing the maximal sets of connected components for subgraphs may be merged to identify maximal sets of connected components of a graph. At step 314, the maximal sets of connected components of a graph may be output as grandparent-parent-child triples (p′,p,v) of vertices.

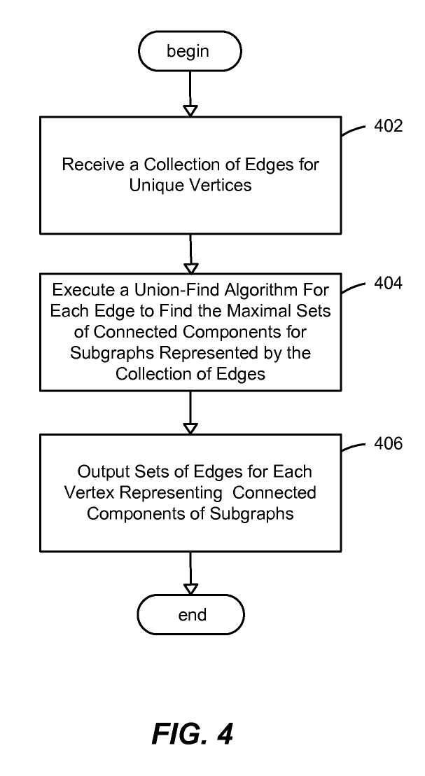

FIG. 4 presents a flowchart for generally representing the steps undertaken in one embodiment for computing subgraphs of connected components of a large-scale graph in a map-reduce framework. At step 402, a collection of edges may be received for unique vertices. For example, one or more subsets of edges denoted by gᵢ=(vᵢ,eᵢ) may be received by a mapper. At step 404, a union-find algorithm may be executed for each edge (v,v′)ε gᵢ in the sets of edges to compute the maximal sets of connected components for subgraphs represented by child-parent pairs of vertices, (vₓ,pₓ). And at step 406, sets of edges for each vertex may be output by child-parent pairs of vertices, (vₓ,pₓ), that represent the connected components for subgraphs.

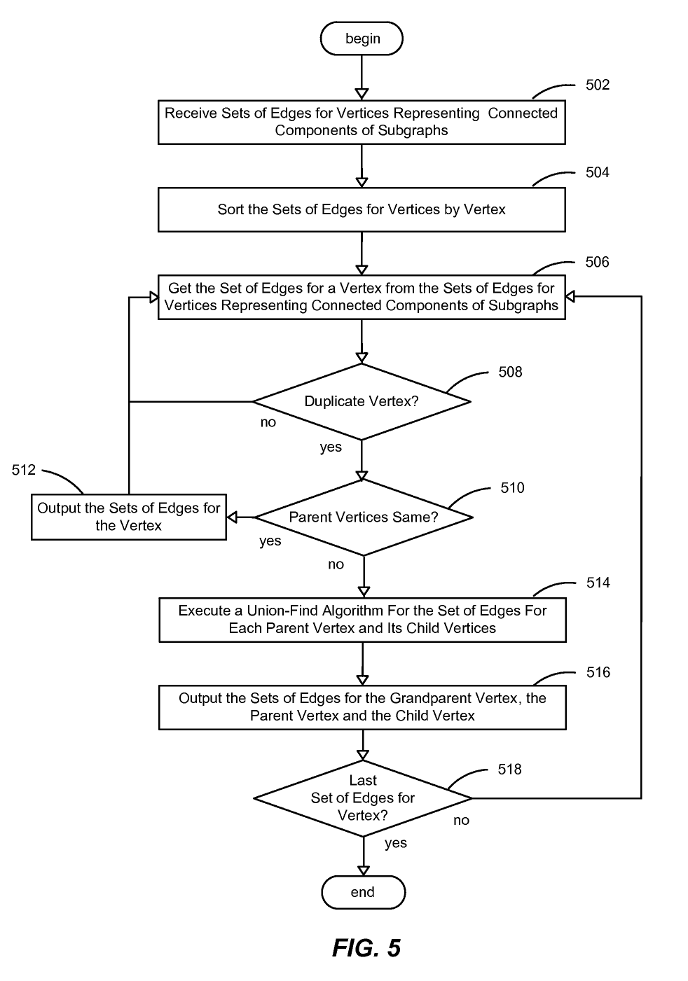

FIG. 5 presents a flowchart for generally representing the steps undertaken in one embodiment for computing the connected components of a large-scale graph from the connected components of subgraphs in a map-reduce framework. At step 502, sets of edges for each vertex may be received by child-parent pairs of vertices, (vₓ,pₓ), that represent the connected components for subgraphs of a large-scale graph. In an embodiment, the sets of edges may be received by a single reducer server for computing the connected components of a large-scale graph from the connected components of subgraphs. At step 504, the sets of edges for each vertex represented by child-parent pairs of vertices, (vₓ,pₓ), may be sorted by child vertex value. In an embodiment where there may be several reducer servers for computing the connected components of a large-scale graph from the connected components of subgraphs, the sets of edges for each vertex may be sorted by child vertex value and then sets of edges for subsets of one or more unique vertices may be sent to different reducer servers for computing the connected components of a large-scale graph from the connected components of subgraphs.

At step 506, a set of edges for a vertex represented by a child-parent pair of vertices that represent the connected components for subgraphs may be obtained from the sets of edges for sorted vertices. It may be determined at step 508 whether the vertex is a duplicate of a vertex previously obtained from the sets of edges for sorted vertices. If not, then the set of edges for the vertex may be output at step 512. Otherwise, it may be determined at step 510 whether the parent vertices of the vertex are the same. If so, then the set of edges for the vertex may be output at step 512 as a grandparent-parent-child triple, (p′,p,v). Otherwise, a union-find algorithm may be executed on the set of edges for each parent vertex and its child vertices at step 514 to find the maximal sets of connected components for the set of edges for each parent vertex and its child vertices. The maximal sets of connected components for the set of edges for each parent vertex and its child vertices may then be output at step 516. In an embodiment, the set of edges for a triple of a grandparent vertex, a parent vertex and a child vertex, (p′,p,v), that represent a maximal set of a connected component may be output for each connected component of the graph. At step 518, it may be determined whether the last set of edges for a vertex from the sets of edges for sorted vertices has been processed. If not, then processing may continue at step 506 where the set of edges for the next vertex may be obtained from the sets of edges for sorted vertices. Otherwise, if the last set of edges for a vertex from the sets of edges for sorted vertices has been processed, then processing may be finished for computing the connected components of a large-scale graph from the connected components of subgraphs in a map-reduce framework. In an embodiment where there may be several reducer servers for computing the connected components of a large-scale graph from the connected components of subgraphs, the output of each of the reducers may be sent to a single reducer to resolve conflicts where a child vertex belongs to multiple parent vertices for computing the connected components of a large-scale graph.

Thus the present invention may compute connected components in parallel across multiple machines for a graph too large to fit the set of vertices and edges into memory on a single machine. Importantly, the system and method may find the connected components without traversing the edges in the graph. The system and method are accordingly scalable and maintain a constant number of passes through the input data. Thus, social network analysis applications involving millions of users with billions of communications may use the present invention to compute the set of connected components to identify which users are reachable within the social network from a given user.

As can be seen from the foregoing detailed description, the present invention provides an improved system and method for finding connected components in a large-scale graph is provided. A map-reduce framework may be implemented for finding weakly connected components by distributing subsets of a collection of edges for unique vertices to several mappers to compute the connected components of subgraphs represented by each subset of edges. Then the sets of edges for connected components of subgraphs may be sorted by vertex. The sets of edges representing connected components of subgraphs may be distributed to one or more reducers to find maximal sets of weakly connected components of the large-scale graph. Advantageously, connected components may be computed in parallel across multiple machines on extremely large graphs in a constant number of passes through the input data. As a result, the system and method provide significant advantages and benefits needed in contemporary computing, and more particularly in online applications that analyze communications between users.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for finding connected components in a graph, comprising:
a mapper that receives a plurality of edges for a plurality of unique vertices and outputs a plurality of sets of edges for each vertex representing a plurality of connected components of a plurality of subgraphs;
a reducer operably coupled to the mapper that receives the plurality of sets of edges for each vertex representing the plurality of connected components of the plurality of subgraphs and finds a plurality of maximal sets of connected components for a graph; and
a storage operably coupled to the reducer that stores the maximal sets of connected components for the graph.

2. The system of claim 1 further comprising a subgraph union-find component operably coupled to the mapper that finds a plurality of maximal sets of connected components for a plurality of subgraphs by executing a union-find algorithm for the plurality of edges for the plurality of unique vertices.

3. The system of claim 1 further comprising a graph union-find component operably coupled to the reducer that finds a plurality of maximal sets of connected components for the graph by executing a union-find algorithm for the plurality of sets of edges for each vertex representing the plurality of connected components of the plurality of subgraphs.

4. A computer-implemented method for finding connected components in a graph, comprising:
receiving a plurality of edges for a plurality of unique vertices;
finding a plurality of sets of edges for each vertex of the plurality of unique vertices that represents at least one connected component of a plurality of subgraphs;
sorting the plurality of sets of edges for each vertex in order by vertex;
finding a plurality of maximal sets of connected components for a graph from the plurality of sets of edges for each vertex; and
outputting a representation of the maximal sets of connected components for the graph.

5. The method of claim 4 further comprising distributing a plurality of subsets of the plurality of edges for a plurality of unique vertices to a plurality of servers that find the plurality of sets of edges for each vertex of the plurality of unique vertices that represents at least one connected component of the plurality of subgraphs.

6. The method of claim 4 further comprising sending a plurality of sets of edges for at least one vertex of the plurality of sets of edges for each vertex of the plurality of unique vertices that represents at least one connected component of the plurality of subgraphs to a server that finds a plurality of maximal sets of connected components for a graph from the plurality of sets of edges for each vertex.

7. The method of claim 4 further comprising outputting a plurality of sets of edges for each vertex representing a plurality of connected components of a plurality of subgraphs.

8. The method of claim 4 further comprising receiving the plurality of sets of edges for each vertex of the plurality of unique vertices that represents at least one connected component of the plurality of subgraphs.

9. The method of claim 4 wherein finding a plurality of sets of edges for each vertex of the plurality of unique vertices that represents at least one connected component of a plurality of subgraphs comprises executing a union-find algorithm for the plurality of edges for the plurality of unique vertices to find a plurality of maximal sets of connected components for the plurality of subgraphs.

10. The method of claim 4 wherein finding the plurality of maximal sets of connected components for the graph from the plurality of sets of edges for each vertex comprises executing a union-find algorithm for the plurality of sets of edges for each vertex.

11. The method of claim 4 wherein outputting the representation of the maximal sets of connected components for the graph further comprising outputting a set of edges for a triple of a grandparent vertex, a parent vertex and a child vertex.

12. The method of claim 4 wherein outputting the representation of the maximal sets of connected components for the graph further comprising storing the representation of the maximal sets of connected components for the graph.

13. The method of claim 7 wherein outputting the plurality of sets of edges for each vertex representing the plurality of connected components of the plurality of subgraphs comprises outputting the set of edges for a tuple of a vertex and its parent vertex.

14. The method of claim 4 wherein finding the plurality of maximal sets of connected components for the graph from the plurality of sets of edges for each vertex comprises:
obtaining one of the plurality of sets of edges for a vertex from the plurality of sets of edges sorted by vertex; and
determining whether the vertex is a duplicate of another vertex previously obtained from the plurality of sets of edges sorted by vertex.

15. The method of claim 14 further comprising determining whether each parent vertex of the vertex is the same.

16. The method of claim 4 wherein finding the plurality of maximal sets of connected components for the graph from the plurality of sets of edges for each vertex comprises executing a union-find algorithm for the plurality of sets of edges for each vertex, its parent vertex, and its child vertex.

17. A computer-readable medium having computer-executable instructions for performing the method of claim 4.

18. A computer system for finding connected components in a graph, comprising:
means for receiving a plurality of edges for a plurality of unique vertices;
means for finding a plurality of sets of edges for each vertex of the plurality of unique vertices that represents at least one connected component of a plurality of subgraphs;
means for finding a plurality of maximal sets of connected components for a graph from the plurality of sets of edges for each vertex; and
means for outputting a representation of the maximal sets of connected components for the graph.

19. The method of claim 18 further comprising means for sorting the plurality of sets of edges for each vertex in order by vertex.

20. The method of claim 18 further comprising means for outputting the plurality of sets of edges for each vertex representing a plurality of connected components of a plurality of subgraphs.
